(19) United States
(12) Patent Application Publication
(10) Pub. No.: US 2002/0037155 A1
(43) Pub. Date: Mar. 28, 2002

(54) Reproducing apparatus and method, and transmission apparatus and method

(76) Inventor: Takashi Kobayashi, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/956,100

(22) Filed: Sep. 20, 2001

(30) Foreign Application Priority Data
Sep. 25, 2000 (JP) 291282/2000

(51) Int. Cl. H04N 5/92; H04N 5/783; G11B 27/00

(52) U.S. Cl. 386/52; 386/68; 386/111

(57) ABSTRACT

At the reproducing side, an audio/video program including Transport-Stream packets of the MPEG(Moving Picture Experts Group)-2 standards into N divided blocks, and Transport-Stream packets within each of the divided blocks are reproduced at a bit rate N times an ordinary bit rate At the reproducing side, Transport-Stream packets within each of the divided blocks are subjected to isochronous transfer in parallel via a corresponding one of N logical signal paths set between the reproducing side and the recording side. At the recording side, Transport-Stream packets within each of the divided blocks are reconfigured, and the reconfigured Transport-Stream packets are recorded at the bit rate N times the ordinary bit rate. According to such a configuration, a desired audio/video program can be dubbed at a high speed.

### BACKGROUND OF THE INVENTION

1. Field of the Invention

The present invention relates to a reproducing apparatus and method, and a transmission apparatus and method in which an audio/video program including digital image data, digital sound data and the like is subjected to digital transmission.

2. Description of the Related Art

Recently, a Transport Stream method of the MPEG (Moving Picture Experts Group)-2 system standards (hereinafter abbreviated as “MPEG-2 TS”) has been known as a data format for transmitting a plurality of audio/video programs in a multiplexed state. The MPEG-2 TS provides that each audio/video program should be configured with a plurality of MPEG-2 TS packets (one MPEG-2 TS packet is a 188-byte fixed-length packet), and the respective MPEG-2 TS packets should be arranged in a time-division state.

Recently, IEEE (the Institute of Electrical and Electronics Engineers, Inc) 1394-1995 High Performance Serial Bus standards (hereinafter abbreviated as “IEEE 1394-1995 standards”) have been proposed as a technique for performing digital transmission of MPEG-2 TS packets.

When transmitting MPEG-2 TS packets of a desired audio/video program using an isochronous transfer mode of the IEEE 1394-1995 standards, the transmission rate is determined in accordance with the bit rate of the program. Accordingly, when performing digital dubbing of a desired audio/video program into an external recording apparatus using a digital interface conforming to the IEEE 1394-1995 standards, the same time period as the time period required for reproducing the program is necessary. As a result, when performing digital dubbing of an audio/video program of several hours, both of the reproducing side and the recording side cannot be used for these hours.

### SUMMARY OF THE INVENTION

An object of the present invention is to solve the above-described problems.

Another object of the present invention is to perform high-speed digital dubbing of a desired audio/video program using a digital interface.

According to one aspect, the present invention which achieves these objectives relates to a reproducing apparatus including reproducing means for reproducing digital information including a plurality of fixed-length packets at a bit rate N (N is a number equal to or larger than 0) times an ordinary bit rate, and transmission means for transmitting the plurality of fixed-length packets reproduced at the bit rate N times the ordinary bit rate to an external recording apparatus via a plurality of logical signal paths.

According to another aspect, the present invention which achieves these objectives relates to a reproducing method including a reproducing step of reproducing digital information including a plurality of fixed-length packets at a bit rate N (N is a number equal to or larger than 0) times an ordinary bit rate, and a transmission step of transmitting the plurality of fixed-length packets reproduced at the bit rate N times the ordinary bit rate to an external recording apparatus via a plurality of logical signal paths.

According to still another aspect, the present invention which achieves these objectives relates to a transmission apparatus including input means for inputting digital information including a plurality of fixed-length packets at a bit rate N (N is a number equal to or larger than 0) times an ordinary bit rate, and transmission means for transmitting the plurality of fixed-length packets reproduced at the bit rate N times the ordinary bit rate to an external recording apparatus via a plurality of logical signal paths.

According to yet another aspect, the present invention which achieves these objectives relates to a transmission method including an input step of inputting digital information including a plurality of fixed-length packets at a bit rate N (N is a number equal to or larger than 0) times an ordinary bit rate, and a transmission step of transmitting the plurality of fixed-length packets reproduced at the bit rate N times the ordinary bit rate to an external recording apparatus via a plurality of logical signal paths.

According to yet a further aspect, the present invention which achieves these objectives relates to a reproducing apparatus including reproducing means for reproducing digital information including Transport-Stream packets of the MPEG((Moving Picture Experts Group)-2 standards at a bit rate N (N is a number equal to or larger than 0) times an ordinary bit rate, and transmission means for transmitting the Transport-Stream packets reproduced at the bit rate N times the ordinary bit rate to an external recording apparatus via a plurality of logical signal paths.

According to still another aspect, the present invention which achieves these objectives relates to a reproducing method including a reproducing step of reproducing digital information including Transport-Stream packets of the MPEG-2 standards at a bit rate N (N is a number equal to or larger than 0) times an ordinary bit rate, and a transmission step of transmitting the Transport-Stream packets reproduced at the bit rate N times the ordinary bit rate to an external recording apparatus via a plurality of logical signal paths.

According to still another aspect, the present invention which achieves these objectives relates to a transmission apparatus including input means for inputting digital information including Transport-Stream packets of the MPEG-2 standards at a bit rate N (N is a number equal to or larger than 0) times an ordinary bit rate, and transmission means for transmitting the Transport-Stream packets input at the bit rate N times the ordinary bit rate to an external recording apparatus via a plurality of logical signal paths.

According to still another aspect, the present invention which achieves these objectives relates to a transmission method including an input step of inputting digital information including Transport-Stream packets of the MPEG-2 standards at a bit rate N (N is a number equal to or larger than 0) times an ordinary bit rate, and a transmission step of transmitting the Transport-Stream packets input at the bit rate N times the ordinary bit rate to an external recording apparatus via a plurality of logical signal paths.

Still other objects of the present invention, and the advantages thereof, will become fully apparent from the following detailed description of the preferred embodiments taken in conjunction with the accompanying drawings.

### BRIEF DESCRIPTION OF THE DRAWINGS

FIG. 1 is a block diagram illustrating the configuration of a dubbing system according to a first embodiment of the present invention;

FIG. 2 is a flowchart illustrating the processing procedure of the dubbing system shown in FIG. 1;

FIG. 3 is a schematic diagram illustrating the details of the processing procedure of an ordinary dubbing method according to the first embodiment;

FIG. 4 is a schematic diagram illustrating the details of the processing procedure of a high-speed dubbing method according to the first embodiment;

FIG. 5 is a schematic diagram illustrating the structure of an isochronous packet;

FIG. 6 is a flowchart illustrating the processing procedure of a dubbing system according to a second embodiment of the present invention; and

FIG. 7 is a schematic diagram illustrating the details of the processing procedure of a high-speed dubbing method according to the second embodiment.

### DETAILED DESCRIPTION OF THE PREFERRED EMBODIMENTS

The preferred embodiments of the present invention will now be described in detail with reference to the accompanying drawings.

(First Embodiment)

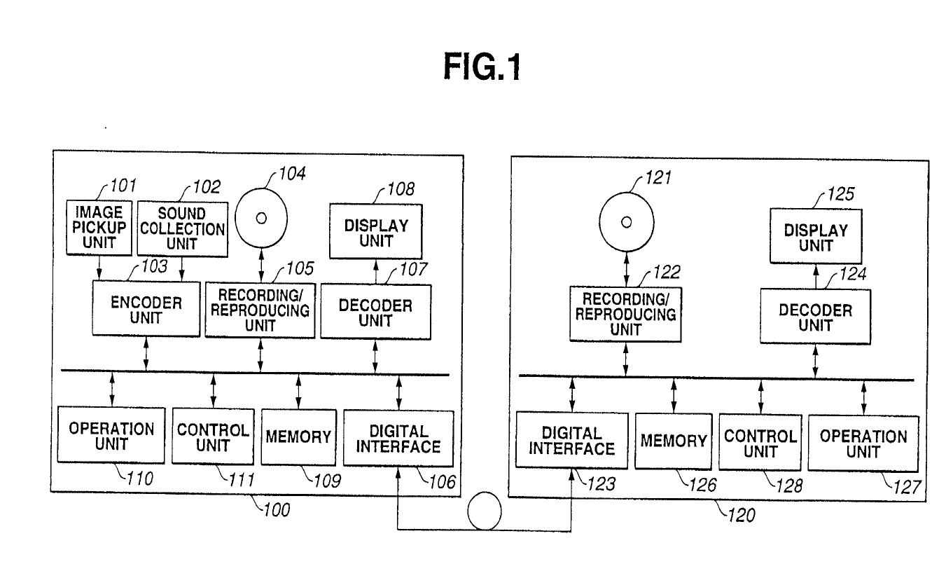

FIG. 1 is a block diagram illustrating the configuration of a dubbing system according to a first embodiment of the present invention. In FIG. 1, there are shown digital camcorders 100 and 120.

Each of the digital camcorders 100 and 120 can record and reproduce, and perform digital input and digital output of an audio/video program (hereinafter abbreviated as an “AV program”, which includes digital image data, digital sound data, auxiliary data of these data, and the like) conforming to the MPEG-2 TS.

Each of the digital camcorders 100 and 120 has a dubbing mode as one of operation modes. The dubbing mode includes two dubbing methods, i.e., an ordinary dubbing method and a high-speed dubbing method.

In the ordinary dubbing method, MPEG-2 TS packets of a predetermined AV program recorded in a recording medium at the reproducing side are reproduced at an ordinary bit rate. The MPEG-2 TS packets reproduced at the ordinary bit rate are subjected to isochronous transfer at an ordinary transmission rate. The MPEG-2 TS packets subjected to isochronous transfer at the ordinary transmission rate are stored in a storage medium at the recording side at the ordinary bit rate.

In the high-speed dubbing method, MPEG-2 TS packets of a predetermined AV program recorded in a recording medium at the reproducing side are reproduced at a bit rate N times an ordinary bit rate. The MPEG-2 TS packets reproduced at the bit rate N times the ordinary bit rate are subjected to isochronous transfer at a transmission rate N times an ordinary transmission rate. The MPEG-2 TS packets subjected to isochronous transfer at the transmission rate N times the ordinary transmission rate are stored in a storage medium at the recording side at the bit rate N times the ordinary bit rate.

Next, the configuration of the digital camcorder 100 will be described with reference to FIG. 1. In FIG. 1, there are shown an image pickup unit 101, a sound collection unit 102, an encoder unit 103, a recording/reproducing unit 105, a recording medium 104, a digital interface 106, a decoder unit 107, a display unit 108, a memory 109, an operation unit 110, and a control unit 111.

In a photographing mode, the image pickup unit 101 converts an optical image of an object into digital image data having a predetermined format, and supplies the encoder unit 103 with the digital image data. The sound collection unit 102 converts a sound signal collected by a microphone or the like into a digital sound data having a predetermined format, and supplies the encoder unit 103 with the digital sound signal.

The encoder unit 103 encodes (high-efficiency encoding) the digital image signal from the image pickup unit 101 and the digital sound signal from the sound collection unit 102 in accordance with the MPEG-2 standards, and generates MPEG-2 TS packets from the encoded digital image data and digital sound data, and auxiliary data of these data. The MPEG-2 TS packets generated by the encoder unit 103 is supplied to the recording/reproducing unit 105.

The recording/reproducing unit 105 records the MPEG-2 TS packets generated by the encoder unit 103 into the recording medium 104, stores the MPEG-2 TS packets received by the digital interface 106 into the recording medium 104, or reproduces the MPEG-2 packets recorded in the recording medium 104. The recording medium 104 of the first embodiment is a randomly accessible storage medium, such as an optical disk, a magnetooptical disk, a hard disk, a semiconductor memory or the like. The MPEG-2 TS packets reproduced from the recording medium 104 are supplied to the digital interface 106 and the memory 109.

The digital interface 106 conforms to the IEEE 1394-1995 standards or extended standards thereof (these standards will be hereinafter termed “IEEE 1394 standards”). The digital interface 106 performs isochronous transfer of the MPEG-2 TS packets reproduced by the recording/reproducing unit 105, or receives MPEG-2 TS packets subjected to isochronous transfer from another apparatus. The MPEG-2 TS packets subjected to isochronous transfer from the other apparatus is supplied to the recording/reproducing unit 105 and the memory 109.

The decoder unit 107 reconfigures an AV program (including digital image data, digital sound data, auxiliary data of these data, and the like) from the MPEG-2 TS packets read from the memory 109, and decodes the reconfigured AV program in accordance with the MPEG-2 standards.

The display unit 108 displays digital image data from the decoder unit 107 on a display, such as a liquid-crystal panel or the like, or outputs digital sound data from the decoder unit 107 using a speaker.

The operation unit 110 includes operation keys, operation buttons, operation panels and the like. By operating the operation unit 110, the user inputs an instruction for controlling the operation of the digital camcorder 100, sets the operation mode of the digital camcorder 100 to a dubbing mode, or sets a dubbing speed when the high-speed dubbing method has been selected.

The control unit 111 controls the operation of the digital camcorder 100, controls the recording rate or the reproducing rate of the recording/reproducing unit 105 in accordance with the selected dubbing speed, selects division of an AV program to be dubbed in accordance with the selected dubbing speed, or controls the number of logical signal paths set between the digital interface 106 and a digital interface at the recording side in accordance with the selected dubbing speed.

Next, the configuration of the digital camcorder 120 will be described with reference to FIG. 1. In FIG. 1, there are shown a recording medium 121, a recording/reproducing unit 122, a digital interface 123, a decoder unit 124, a display unit 125, a memory 126, an operation unit 127, and a control unit 128.

The recording/reproducing unit 122 stores MPEG-2 TS packets received by the digital interface 123 into the recording medium 121, or reproduces MPEG-2 packets recorded in the recording medium 121. As the recording medium 104, the recording medium 121 of the first embodiment is a randomly accessible storage medium, such as an optical disk, a magnetooptical disk, a hard disk, a semiconductor memory or the like. MPEG-2 TS packets corresponding to a desired AV program reproduced from the recording medium 121 are supplied to the digital interface 123 and the memory 126.

As the digital interface 106, the digital interface 123 conforms to the IEEE 1394 standards. The digital interface 123 performs isochronous transfer of MPEG-2 TS packets reproduced by the recording/reproducing unit 122, or receives MPEG-2 TS packets subjected to isochronous transfer from another apparatus. The MPEG-2 TS packets subjected to isochronous transfer from the other apparatus is supplied to the recording/reproducing unit 122 and the memory 126.

The decoder unit 124 recofigures an AV program (including digital image data, digital sound data, auxiliary data of these data, and the like) from the MPEG-2 TS packets read from the memory 126, and decodes the reconfigured AV program in accordance with the MPEG-2 standards.

The display unit 125 displays digital image data from the decoder unit 124 on a display, such as a liquid-crystal panel or the like, or outputs digital sound data from the decoder unit 124 using a speaker.

The operation unit 127 includes operation keys, operation buttons, operation panels and the like. By operating the operation unit 127, the user inputs an instruction for controlling the operation of the digital camcorder 120, sets the operation mode of the digital camcorder 120 to a dubbing mode, or sets a dubbing speed when the high-speed dubbing method has been selected.

The control unit 128 controls the operation of the digital camcorder 120, controls the reproducing rate or the recording rate of the recording/reproducing unit 122 in accordance with the selected dubbing speed, selects division of an AV program to be dubbed in accordance with the selected dubbing speed, or controls the number of logical signal paths set between the digital interface 123 and a digital interface at the reproducing side in accordance with the selected dubbing speed.

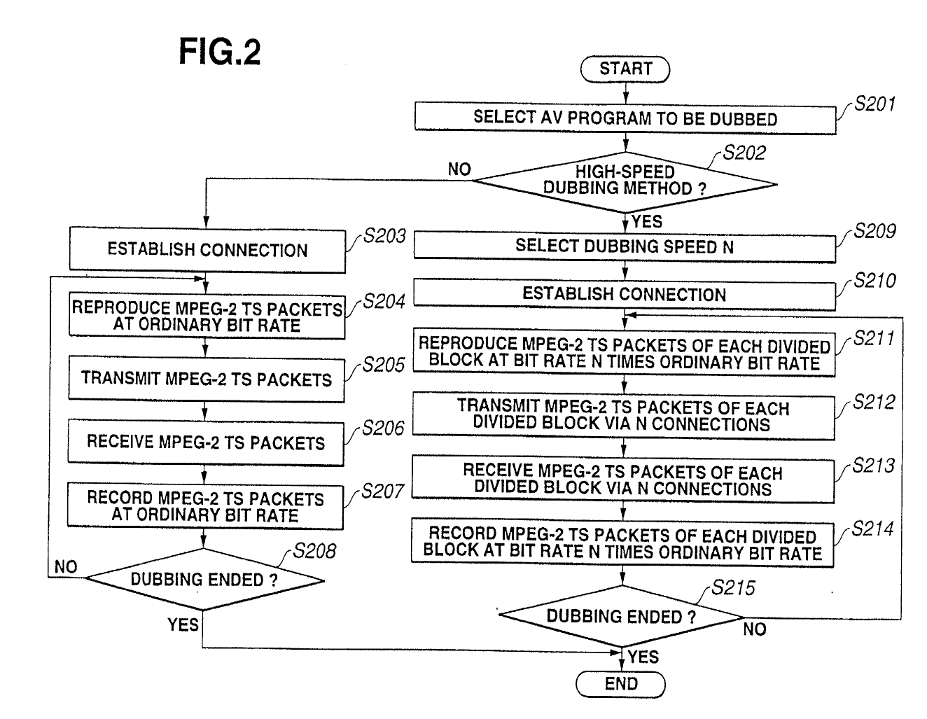

Next, a description will be provided of the processing procedure of a dubbing system according to the first embodiment, with reference to FIGS. 2-5.

FIG. 2 is a flowchart illustrating the processing procedure of the dubbing system of the first embodiment. In the first embodiment, the camcorder 100 is used at the reproducing side (transmission side), and the digital camcorder 120 is used at the recording side (reception side). A description will now be provided of a procedure of dubbing an AV program selected by the user, between the digital camcorder 100 and the digital camcorder 120, according to the ordinary dubbing method or the high-speed dubbing method.

In step S201, after setting the current operation mode to the dubbing mode by operating the operation unit 110 of the digital camcorder 100, the user selects an AV program to be dubbed into the digital camcorder 120 from among AV programs recorded in the recording medium 104. In the first embodiment, a case of selecting an AV program A having a bit rate of about 5 Mbps will be described.

In step S202, the control unit 111 of the digital camcorder 100 asks the user about the dubbing method for the AV program A. When the user has selected the ordinary dubbing method, the process proceeds to step S203. When the user has selected the high-speed dubbing method, the process proceeds to step S209.

First, a description of provided of the case in which the user has selected the ordinary dubbing method. In this case, the digital camcorder 100 notifies the digital camcorder 120 that the ordinary dubbing method has been selected.

In step S203, the digital interface of the digital camcorder 100 acquires an isochronous resource necessary for ordinary dubbing of the AV program A, and establishes a logical signal path (connection) between the digital interfaces 106 and 123.

In step S204, the recording/reproducing unit 105 of the digital camcorder 100 reproduces MPEG-2 TS packets of the AV program A from the recording medium 104 at an ordinary bit rate. The reproduced MPEG-2 TS packets are supplied to the digital interface 106 and the memory 106.

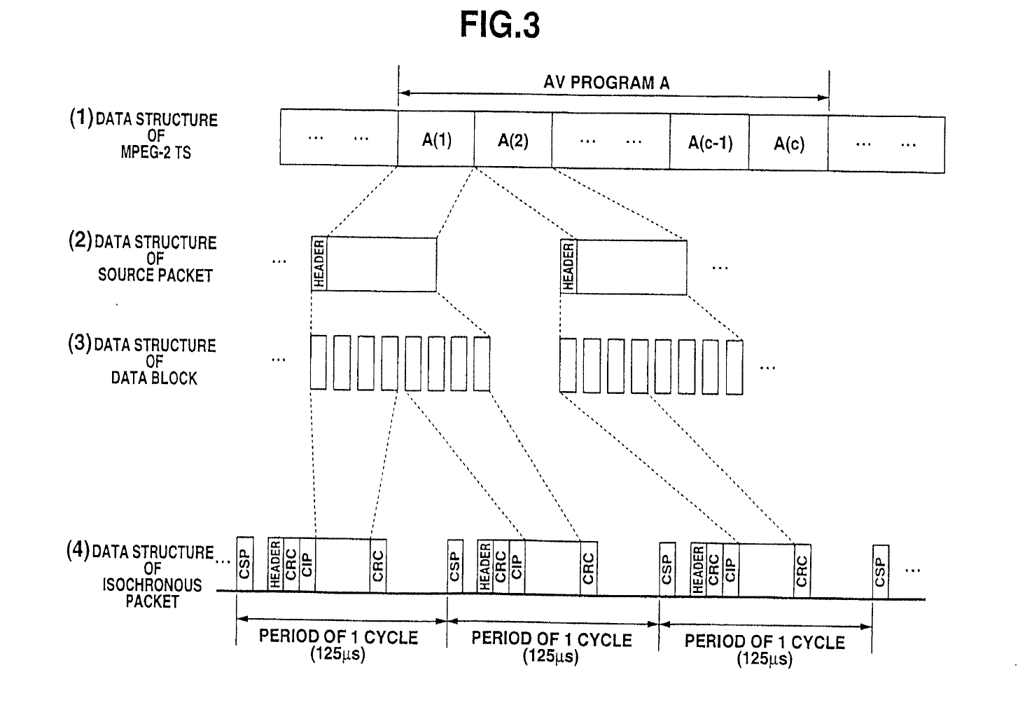

In step S205, the recording/reproducing unit 106 of the digital camcorder 100 generates isochronous packets from the MPEG-2 TS packets of the AV program A in accordance with the procedure shown in FIG. 3. The generated isochronous packets are subjected to isochronous transfer via the connection set in step S203.

The processing procedure of the ordinary dubbing method according to the first embodiment will now be described in detail with reference to FIG. 3.

FIG. 3(1) is a diagram illustrating the data structure of MPEG-2 TS recorded in the recording medium 104. Each of MPEG-2 TS packets A(1)-A(c) constituting the AV program A is a 188-byte fixed-length packet. The recording/reproducing unit 105 sequentially reproduces the MPEG-2 TS packets A(1)-A(c) of the AV program A at an ordinary bit rate, and supplies the digital interface 106 with the reproduced packets.

FIG. 3(2) is a diagram illustrating the procedure for generating a source packet from each of the MPEG-2 TS packets. The digital interface 106 provides each of the MPEG-2 TS packets A(1)-A(c) supplied from the recording/reproducing unit 105 with a 4-byte source-packet header, and generates a source packet (comprising 192 bytes). The source-packet header includes a 25-bit time stamp (time information). The reception side controls the timing of reproducing the AV program A by referring to the time stamp.

FIG. 3(3) is a diagram illustrating the procedure for generating data blocks from each source packet. The digital interface 106 divides each source packet into 24-byte data blocks. That is, eight data blocks are generated from one source packet.

FIG. 3(4) is a diagram illustrating the procedure for generating one isochronous packet from a plurality of data blocks. The digital interface 106 determines the number M (M=1, 2, 4, 8, or a multiple of 8) of data blocks to be stored in one isochronous packet in accordance with the bit rate of the AV program A.

The relationship between the number M of data blocks to be stored in one isochronous packet and the transmission rate is as follows:

when M=1, the transmission rate is 1.504 Mbps;

when M=2, the transmission rate is 3.008 Mbps;

when M=4, the transmission rate is 6.016 Mbps;

when M=8, the transmission rate is 12.032 Mbps;

when M=16, the transmission rate is 24.064 Mbps;

when M=24, the transmission rate is 36.096 Mbps; and

when M=32, the transmission rate is 48.128 Mbps.

When performing isochronous transfer of the AV program A comprising about 5 Mbps as in the first embodiment, four data blocks are stored in one isochronous packet. Each isochronous packet storing four data blocks is subjected to isochronous transfer at every communication cycle period of about 125 μs via one connection.

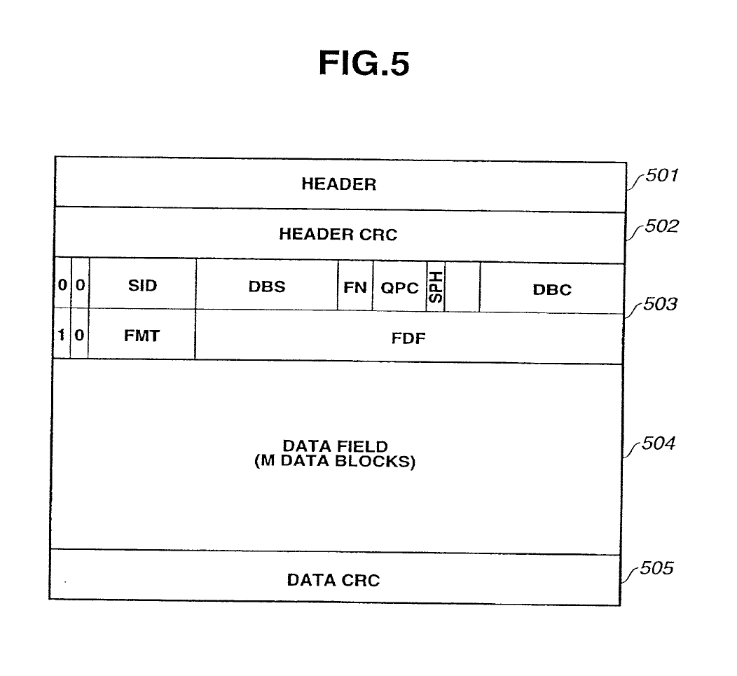

Next, the basic structure of the isochronous packet will be described with reference to FIG. 5.

In FIG. 5, there are shown a header 501 of the isochronous packet, header CRC (cyclic redundancy check) for the header 501, a CIP (common isochronous packet) header 503, a data field 504 storing M data blocks, and data CRC for the CIP header 503 and the data field 504 .

In the CIP header 503, a node ID of a node which transmits the isochronous packet is stored in SID (source node ID). In the first embodiment, since the digital camcorder 100 operates as the transmission node, the node ID allocated to the digital camcorder 100 is stored. A code indicating the data size of one data block is stored in a DBS (data block size). In the first embodiment, since the data size of one data block is 24 bytes, a code indicating “24 bytes” is stored. A code indicating the number of data blocks divided from one source packet is stored in an FN (fraction number). In the first embodiment, since one source packet is divided into eight data blocks, a code indicating “8” is stored. A code indicating whether or not a source packet header is provided is stored in an SPH (source packet header). In the first embodiment, since a source packet header is provided, a code indicating “present” is stored. A count value indicating continuity of data blocks is stored in a DBC (data block count). A code indicating the data format of data stored in the data field 504 is stored in FMT (format ID). In the first embodiment, since M data blocks generated from a MPEG-2 TS packet are stored, a code indicating MPEG-2 TS is stored.

In step S206, the digital interface 123 of the digital camcorder 120 receives isochronous packets subjected to isochronous transfer via one connection, and reconfigures MPEG-2 TS packets of the AV program A from the received isochronous packets. The reconfigured MPEG-2 TS packets are supplied to the recording/reproducing unit 122 and the memory 126.

In step S207, the recording/reproducing unit 122 of the digital camcorder 120 records the MPEG-2 TS packets supplied from the digital interface 123 into the recording medium 121.

In step S208, the control unit 111 of the digital camcorder 100 determines whether or not dubbing of the AV program A has been completed. If the result of the determination in step S208 is affirmative, the user is notified that the ordinary dubbing of the AV program A has been completed, using the operation unit 110 or the display unit 108.

Next, a description will be provided of a case in which the user has selected the high-speed dubbing method. At that time, the digital camcorder 100 notified the digital camcorder 120 that the high-speed dubbing method has been selected.

In step S209, the control unit 111 of the digital camcorder 100 obtains dubbing speeds which can be currently selected, based on the bit rate of the AV program A, the reproducing capability and the transmission capability of the digital camcorder 100, the reception capability and the recording capability of the digital camcorder 120, an isochronous resource which can be currently utilized (the channel number and the bandwidth necessary in the isochronous transfer mode of the IEEE 1394 standards), and the like. The dubbing speeds obtained by the control unit 111 are notified to the user using the operation unit 110 or the display unit 108. The user selects a desired dubbing speed N (N is an integer equal to or lager than 2) from among the dubbing speeds notified using the operation unit 110 or the display unit 108. The selected dubbing speed N is notified from the digital camcorder 100 to the digital camcorder 120.

In step S210, the digital interface 106 of the digital camcorder 100 acquires an isochronous resource necessary for n-time-speed dubbing of the AV program A, and establishes N logical signal paths (connections) between the digital interfaces 106 and 123. By establishing the N connections, the digital interface 106 can realize a transmission rate N times the ordinary transmission rate.

In step S211, the recording/reproducing unit 105 of the digital camcorder 100 divides the AV program A into N divided blocks, and alternately reproduces MPEG-2 TS packets of the respective divided blocks from the recording medium 104 with a bit rate N times the ordinary bit rate. MPEG-2 TS packets of the respective divided blocks are supplied to the digital interface 106 and the memory 109.

When confirming the AV program A subjected to digital dubbing with an N-time speed at the reproducing side, the decoder unit 124 selects one of the divided blocks, reads MPEG-2 TS packets of the selected divided block from the memory 109, and decodes the read packets. The divided block to be decoded can be switched using the operation unit 110. Digital image data and digital sound data decoded by the decoder unit 107 are output onto the display unit 108 with an ordinary reproducing speed. According to such a configuration, the user can confirm the contents of a part of the AV program A subjected to high-speed dubbing on the display unit of the reproducing side with the ordinary reproducing speed.

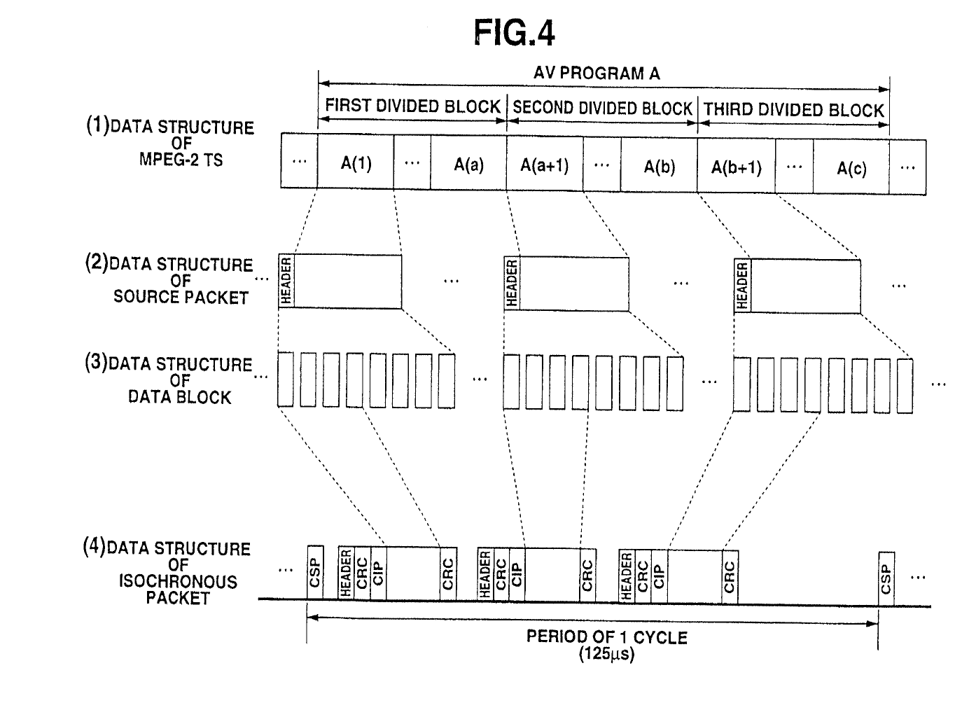

In step S212, the digital interface 106 of the digital camcorder 100 generates isochronous packets from MPEG-2 TS packets of the N divided blocks in accordance with the procedure shown in FIG. 4. The generated isochronous packets are subjected to isochronous transfer to the digital interface 123 of the digital camcorder 120 via N connections corresponding to the respective divided blocks.

An example of the processing procedure of the high-speed dubbing according to the first embodiment will now be described in detail with reference to FIG. 4. FIG. 4 illustrates a case of dubbing the AV program A at a speed three times an ordinary speed.

FIG. 4(1) is a diagram illustrating the data structure of MPEG-2 TS recorded in the recording medium 104. Each of MPEG-2 TS packets A(1)-A(c) constituting the AV program A is a 188-byte fixed-length packet. The recording/reproducing unit 105 divides the AV program A into three divided blocks, alternately reproduces MEPG-2 TS packets of the respective divided blocks at a bit rate three times the ordinary bit rate, and supplies the digital interface 106 with the reproduced packets.

FIG. 4(2) is a diagram illustrating the procedure for generating a source packet from each of the MPEG-2 TS packets. The digital interface 106 provides each of the MPEG-2 TS packets of each of the divided blocks with a 4-byte source-packet header, and generates a source packet (comprising 192 bytes). The source-packet header includes a 25-bit time stamp (time information). The reception side controls the timing of reproducing the AV program A by referring to the time stamp.

FIG. 4(3) is a diagram illustrating the procedure for generating data blocks from each source packet. The digital interface 106 divides the source packet of each of the divided blocks into 24-byte data blocks. That is, eight data blocks are generated from one source packet.

FIG. 4(4) is a diagram illustrating the procedure for generating one isochronous packet from a plurality of data blocks. The digital interface 106 determines the number M (M=1, 2, 4, 8, or a multiple of 8) of data blocks to be stored in one isochronous packet in accordance with the bit rate of the AV program A. When performing isochronous transfer of the AV program A comprising about 5 Mbps as in the first embodiment, four data blocks are stored in one isochronous packet. The digital interface 106 generates the isochronous packet for each of the divided blocks. The isochronous packet of each of the divided blocks is subjected to isochronous transfer at every communication cycle period of about 125 μs via a connection corresponding to each of the divided blocks.

In step S213, the digital interface 123 of the digital camcorder 120 receives isochronous packets subjected to isochronous transfer via N connections, and reconfigures MPEG-2 TS packets of the respective divided blocks from the received isochronous packets. The reconfigured MPEG-2 TS packets of the respective divided blocks are supplied to the recording/reproducing unit 122 and the memory 126. In step S214, the recording/reproducing unit 122 of the digital camcorder 120 records the MPEG-2 TS packets of the respective divided blocks supplied from the digital interface 123 into the recording medium 121 at a bit rate N times the ordinary bit rate.

When confirming the AV program A subjected to digital dubbing at an N-time speed at the reproducing side, the decoder unit 124 selects one of the divided blocks, reads MPEG-2 TS packets of the selected divided block from the memory 126, and decodes the read packets. The divided block to be decoded can be switched using the operation unit 110. Digital image data and digital sound data decoded by the decoder unit 124 are output onto the display unit 125 at an ordinary reproducing speed. According to such a configuration, the user can confirm the contents of a part of the AV program A subjected to high-speed dubbing on the display unit of the reproducing side at the ordinary reproducing speed.

In step S215, the control unit 111 of the digital camcorder 100 determines whether or not dubbing of the AV program A has been completed. If the result of the determination in step S215 is affirmative, the user is notified that the high-speed dubbing of the AV program A has been completed, using the operation unit 110 or the display unit 108.

As described above, according to the first embodiment, one AV program is divided into N divided blocks in accordance with the dubbing speed N, and the respective divided blocks can be subjected to isochronous transfer via N connections. Hence, an AV program of the MPEG-2 TS method can be dubbed at a high speed.

According to the first embodiment, the contents of a part of an AV program dubbed at a high speed can be confirmed both at the reproducing side and the recording side at an ordinary reproducing speed.

(Second Embodiment)

Next, a description will be provided of a dubbing system according to a second embodiment of the present invention with reference to FIG. 1.

In the second embodiment, a description will be provided of a dubbing system in which a plurality of AV programs are dubbed at a high speed at a time by establishing a connection for each of the plurality of AV programs.

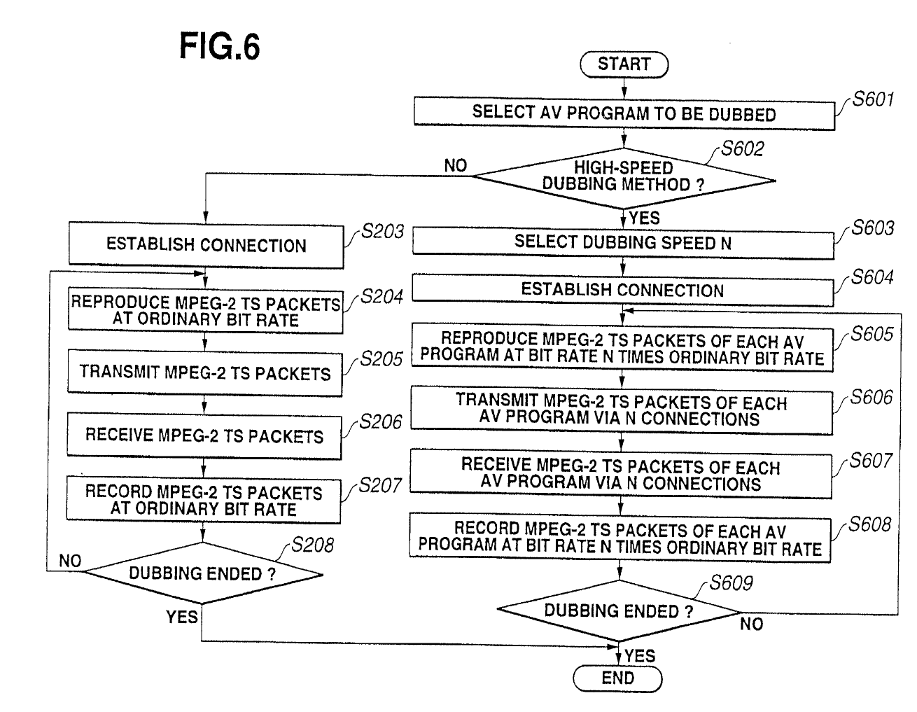

FIG. 6 is a flowchart illustrating the processing procedure of the dubbing system of the second embodiment. In the second embodiment, the camcorder 100 is used at the reproducing side (transmission side), and the digital camcorder 120 is used at the recording side (reception side). A description will now be provided of a procedure of dubbing N AV programs selected by the user between the digital camcorder 100 and the digital camcorder 120. In FIG. 6, steps having the same functions as those shown in FIG. 2 are indicated by the same numerals, and further description thereof will be omitted.

In step S601, after setting the current operation mode to the dubbing mode by operating the operation unit 110 of the digital camcorder 100, the user selects a plurality of AV programs to be dubbed into the digital camcorder 120 from among AV programs recorded in the recording medium 104. In the second embodiment, a case of selecting AV programs A, B and C having a bit rate of about 5 Mbps will be described.

In step S602, the control unit 111 of the digital camcorder 100 asks the user about the dubbing method for the AV programs A, B and C. When the user has selected the ordinary dubbing method, the process proceeds to step S203. When the user has selected the high-speed dubbing method, the process proceeds to step S209.

The case in which the user has selected the ordinary dubbing method (steps S203-S208) requires the same processing as that shown in FIG. 2. Hence, further description thereof will be omitted. More specifically, dubbing is performed in the order of the AV programs A, B and C at the ordinary bit rate.

Next, a description will be provided of a case in which the user has selected the high-speed dubbing method. At that time, the digital camcorder 100 notified the digital camcorder 120 that the high-speed dubbing method has been selected.

In step S603, the control unit 111 of the digital camcorder 100 obtains a dubbing speed N (N is the number of programs selected in step S601, N=3 in this case) which can be currently selected, based on the number of AV programs to be dubbed, the bit rate of the AV programs A, B and C, the reproducing capability and the transmission capability of the digital camcorder 100, the reception capability and the recording capability of the digital camcorder 120, an isochronous resource which can be currently utilized (the channel number and the bandwidth necessary in the isochronous transfer mode of the IEEE 1394 standards), and the like. The dubbing speed N obtained by the control unit 111 is notified to the user using the operation unit 110 or the display unit 108. The dubbing speed N is notified from the digital camcorder 100 to the digital camcorder 120.

In step S604, the digital interface 106 of the digital camcorder 100 acquires an isochronous resource necessary for N-time-speed dubbing of the AV program A, B and C, and establishes N logical signal paths (connections) between the digital interfaces 106 and 123. By establishing the N connections, the digital interface 106 can realize a transmission rate N times the ordinary transmission rate.

In step S605, the recording/reproducing unit 105 of the digital camcorder 100 alternately reproduces MPEG-2 TS packets of the respective AV programs A, B and C from the recording medium 104 at a bit rate N times the ordinary bit rate. MPEG-2 TS packets of each of the divided blocks are supplied to the digital interface 106 and the memory 109.

When confirming the AV program A, B and C subjected to digital dubbing at an N-time speed at the reproducing side, the decoder unit 124 selects one of the AV programs A, B and C, reads MPEG-2 TS packets of the selected AV program from the memory 109, and decodes the read AV program. The AV program to be decoded can be switched using the operation unit 110. Digital image data and digital sound data decoded by the decoder unit 107 are output onto the display unit 108 at an ordinary reproducing speed. According to such a configuration, the user can confirm the contents of one of the AV program A, B and C subjected to high-speed dubbing on the display unit of the reproducing side at the ordinary reproducing speed.

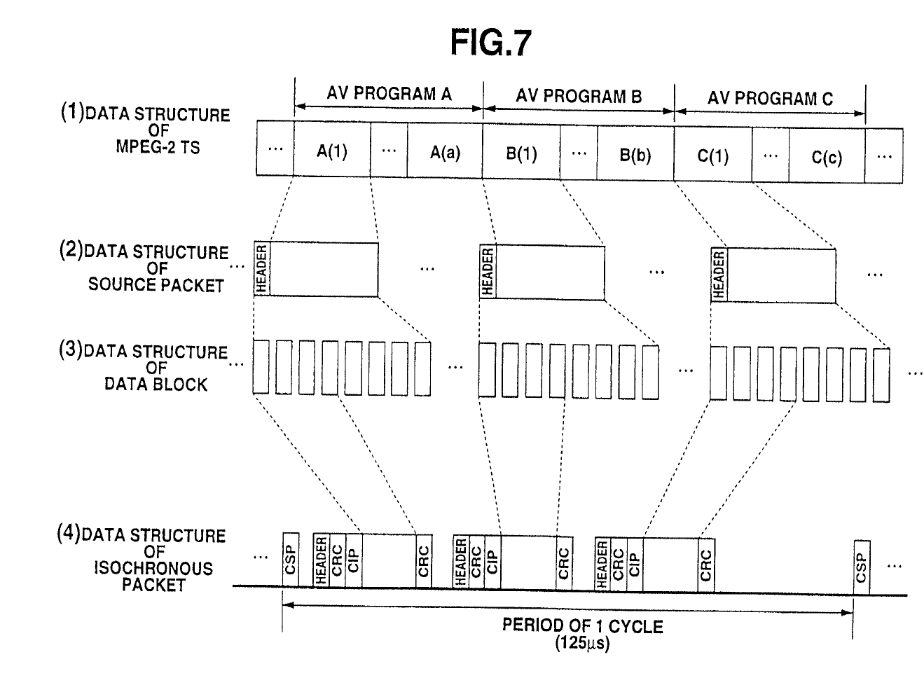

In step S212, the digital interface 106 of the digital camcorder 100 generates isochronous packets from MPEG-2 TS packets of the AV programs A, B and C in accordance with the procedure shown in FIG. 7. The generated isochronous packets are subjected to isochronous transfer to the digital interface 123 of the digital camcorder 120 via N connections corresponding to the AV programs A, B and C.

An example of the processing procedure of the high-speed dubbing according to the second embodiment will now be described in detail with reference to FIG. 7. FIG. 7 illustrates a case of dubbing the AV program A, B and C at a speed three times an ordinary speed.

FIG. 7(1) is a diagram illustrating the data structure of MPEG-2 TS recorded in the recording medium 104. Each of MPEG-2 TS packets constituting the AV programs A, B and C is a 188-byte fixed-length packet. The recording/reproducing unit 105 alternately reproduces the AV programs A, B and C at a bit rate three times an ordinary bit rate, and supplies the digital interface 106 with the reproduced packets.

FIG. 7(2) is a diagram illustrating the procedure for generating a source packet from each of the MPEG-2 TS packets. The digital interface 106 provides each of the MPEG-2 TS packets of each of the AV programs A, B and C at a 4-byte source-packet header, and generates a source packet (comprising 192 bytes). The source-packet header includes a 25-bit time stamp (time information). The reception side controls the timing of reproducing the AV programs A, B and C by referring to the time stamp.

FIG. 7(3) is a diagram illustrating the procedure for generating data blocks from each source packet. The digital interface 106 divides the source packet of each of the AV programs A, B and C into 24-byte data blocks. That is, eight data blocks are generated from one source packet.

FIG. 7(4) is a diagram illustrating the procedure for generating one isochronous packet from a plurality of data blocks. The digital interface 106 determines the number M (M=1, 2, 4, 8, or a multiple of 8) of data blocks to be stored in one isochronous packet in accordance with the bit rate of the each of the AV programs A, B and C. When performing isochronous transfer of the AV programs A, B and C, each comprising about 5 Mbps, as in the second embodiment, four data blocks are stored in one isochronous packet. The digital interface 106 generates the isochronous packet for each of the AV programs A, B and C. The isochronous packet of each of the AV programs A, B and C is subjected to isochronous transfer at every communication cycle period of about 125 μs via a connection corresponding to each of the AV programs A, B and C.

In step S213, the digital interface 123 of the digital camcorder 120 receives isochronous packets subjected to isochronous transfer via N connections, and reconfigures MPEG-2 TS packets of each of the AV programs A, B and C from the received isochronous packets. The reconfigured MPEG-2 TS packets of each of the AV programs A, B and C are supplied to the recording/reproducing unit 122 and the memory 126.

In step S214, the recording/reproducing unit 122 of the digital camcorder 120 records the MPEG-2 TS packets of the AV programs A, B and C supplied from the digital interface 123 into the recording medium 121 at a bit rate N times the ordinary bit rate.

When confirming the AV programs A, B and C subjected to digital dubbing at an N-time speed at the reproducing side, the decoder unit 124 selects one of the AV programs A, B and C, reads MPEG-2 TS packets of the selected AV program from the memory 126, and decodes the read packets. The divided block to be decoded can be switched using the operation unit 127. Digital image data and digital sound data decoded by the decoder unit 124 are output onto the display unit 125 at an ordinary reproducing speed. According to such a configuration, the user can confirm the contents of one of the AV programs A, B and C subjected to high-speed dubbing on the display unit of the reproducing side at the ordinary reproducing speed.

In step S215, the control unit 111 of the digital camcorder 100 determines whether or not dubbing of the AV programs A, B and C has been completed. If the result of the determination in step S215 is affirmative, the user is notified that the high-speed dubbing of the AV programs A, B and C has been completed, using the operation unit 110 or the display unit 108.

As described above, according to the second embodiment, since data blocks of each AV program can be stored in one isochronous packet, a plurality of AV programs can be dubbed at a high speed at a time.

According to the second embodiment, the contents of one of a plurality of AV programs being dubbed at a high speed can be confirmed both at the reproducing side and the recording side at an ordinary reproducing speed.

According to the second embodiment, since N different AV programs can be subjected to isochronous transfer via N connections, the N different AV programs can be dubbed at a high speed at a time.

According to the second embodiment, the contents of one of a plurality of AV programs being subjected to digital dubbing at a high speed can be confirmed both at the reproducing side and the recording side at an ordinary reproducing speed.

(Other Embodiments)

Although in the foregoing embodiments, the case of using the digital camcorders 100 and 120 as the reproducing side (transmission side) and the recording side (reception side), respectively, has been described, the present invention is not limited to such a configuration. The digital camcorders 120 and 100 may be used as the reproducing side (transmission side) and the recording side (reception side), respectively.

Although in the foregoing embodiments, the case of selecting an AV program to be dubbed and determining the dubbing speed of the selected AV program at the digital camcorder 100, serving as the reproducing side, has been described, the present invention is not limited to such a configuration. An AV program to be dubbed may be selected and the dubbing speed of the selected AV program may be determined at the digital camcorder 120, serving as the recording side.

Although in the foregoing embodiments, the case of dubbing an AV program of the MPEG-2 TS method between the digital camcorders 100 and 120 has been described, the present invention is not limited to such a configuration. Each of the above-described embodiments may also be realized between a plurality of digital camcorders 100, or between a plurality of digital camcorders 120.

The functions of the above-described embodiments may also be realized by software. In this case, the functions of each of the above-described embodiments are realized by supplying a computer (a CPU (central processing unit) or an MPU (microprocessor unit)) within an apparatus or a system of the embodiment with a storage medium storing program codes of software for realizing the functions of the embodiment, and controlling the apparatus or the system of the embodiment by the computer within the apparatus or the system in accordance the program codes stored in the storage medium.

In this case, the program codes themselves of the software realize the functions of the above-described embodiments. For example, a floppy disk, a hard disk, an optical disk, a magnetooptical disk, a CD (compact disc)-ROM (read-only memory), a magnetic tape, a nonvolatile memory card, a ROM or the like may be used as the storage medium for supplying the program codes.

The individual components designated by blocks in the drawings are all well known in the reproducing apparatus and method and transmission apparatus and method arts and their specific construction and operation are not critical to the operation or the best mode for carrying out the invention.

The invention may be embodied in other specific forms without departing from essential characteristics thereof. Therefore, the above described embodiments are merely exemplary of this invention, and are not to be construed to limit the scope of the present invention. The scope of the present invention is defined by the scope of the appended claims, and is not limited to only the specific descriptions in this specification. Furthermore, all the modifications and changes belonging to equivalents of the claims are considered to fall within the scope of the present invention.

What is claimed is:

1. A reproducing apparatus comprising:
reproducing means for reproducing digital information including a plurality of fixed-length packets at a bit rate N (N is a number equal to or larger than 0) times an ordinary bit rate; and
transmission means for transmitting the plurality of fixed-length packets reproduced at the bit rate N times the ordinary bit rate to an external recording apparatus via a plurality of logical signal paths.

2. A reproducing apparatus according to claim 1, wherein each of the plurality of fixed-length packets is a Transport-Stream packet of the MPEG(Moving Picture Experts Group)-2 standards.

3. A reproducing apparatus according to claim 1 or 2, wherein the plurality of fixed-length packets are transmitted using a digital interface conforming to the IEEE (Institute of Electrical and Electronics Engineers, Inc) 1394-1995 standards.

4. A reproducing apparatus according to any one of claims 1-3, wherein the plurality of fixed-length packets are transmitted at every predetermined communication cycle period.

5. A reproducing apparatus according to any one of claims 1-4, further comprising a display unit for displaying the digital information reproduced at the bit rate N times the ordinary bit rate at the ordinary bit rate.

6. A reproducing apparatus according to any one of claims 1-5, wherein said transmission means sets the plurality of logical signal paths in accordance with a speed of recording the digital information into the external apparatus.

7. A reproducing method comprising:
a reproducing step of reproducing digital information including a plurality of fixed-length packets at a bit rate N (N is a number equal to or larger than 0) times an ordinary bit rate; and
a transmission step of transmitting the plurality of fixed-length packets reproduced at the bit rate N times the ordinary bit rate to an external recording apparatus via a plurality of logical signal paths.

8. A reproducing method according to claim 7, wherein each of the plurality of fixed-length packets is a Transport-Stream packet of the MPEG-2 standards.

9. A reproducing method according to claim 7 or 8, wherein the plurality of fixed-length packets are transmitted using a digital interface conforming to the IEEE 1394-1995 standards.

10. A reproducing method according to any one of claims 7-9, wherein the plurality of fixed-length packets are transmitted at every predetermined communication cycle period.

11. A reproducing method according to any one of claims 7-10, further comprising a display step of displaying the digital information reproduced at the bit rate N times the ordinary bit rate on a display unit at the ordinary bit rate.

12. A reproducing method according to any one of claims 7-11, wherein in said transmission step, the plurality of logical signal paths are set in accordance with a speed of recording the digital information into the external apparatus.

13. A transmission apparatus comprising:
input means for inputting digital information including a plurality of fixed-length packets at a bit rate N (N is a number equal to or larger than 0) times an ordinary bit rate; and
transmission means for transmitting the plurality of fixed-length packets input at the bit rate N times the ordinary bit rate to an external recording apparatus via a plurality of logical signal paths.

14. A transmission method comprising:
an input step of inputting digital information including a plurality of fixed-length packets at a bit rate N (N is a number equal to or larger than 0) times an ordinary bit rate; and
a transmission step of transmitting the plurality of fixed-length packets input at the bit rate N times the ordinary bit rate to an external recording apparatus via a plurality of logical signal paths.

15. A reproducing apparatus comprising:
reproducing means for reproducing digital information including Transport-Stream packets of the MPEG-2 standards at a bit rate N (N is a number equal to or larger than 0) times an ordinary bit rate; and
transmission means for transmitting the Transport-Stream packets reproduced at the bit rate N times the ordinary bit rate to an external recording apparatus via a plurality of logical signal paths.

16. A reproducing method comprising:
a reproducing step of reproducing digital information including Transport-Stream packets of the MPEG-2 standards at a bit rate N (N is a number equal to or larger than 0) times an ordinary bit rate; and
a transmission step of transmitting the Transport-Stream packets reproduced at the bit rate N times the ordinary bit rate to an external recording apparatus via a plurality of logical signal paths.

17. A transmission apparatus comprising:
input means for inputting digital information including Transport-Stream packets of the MPEG-2 standards at a bit rate N (N is a number equal to or larger than 0) times an ordinary bit rate; and
transmission means for transmitting the Transport-Stream packets input at the bit rate N times the ordinary bit rate to an external recording apparatus via a plurality of logical signal paths.

18. A transmission method comprising:
an input step of inputting digital information including Transport-Stream packets of the MPEG-2 standards at a bit rate N (N is a number equal to or larger than 0) times an ordinary bit rate; and
a transmission step of transmitting the Transport-Stream packets input at the bit rate N times the ordinary bit rate to an external recording apparatus via a plurality of logical signal paths.
